(19) United States
(12) Patent Application Publication
(10) Pub. No.: US 2010/0104666 A1
(43) Pub. Date: Apr. 29, 2010

(54) Animal Repellant & Method of Use Thereof

(76) Inventor: Marilyn Cox, Chapel Hill, NC (US)

Correspondence Address: Marilyn Cox, 100 Quarry Place, Chapel Hill, NC, 27517, US

(21) Appl. No.: 12/257,719

(22) Filed: Oct. 24, 2008

(51) Int. Cl. A01N 59/02; A01N 65/42; A01P 17/00

(52) U.S. Cl. 424/705; 424/754

(57) ABSTRACT

A new Animal Repellent & Method of Use Thereof which generally comprises a composition of materials or ingredients that combine to create a new and novel animal repellant that is embodied in liquid or granular form, and can be applied as a spray directly to plant parts or sprinkled on or combined with the soil or mulch bed as a granule to discourage activities such as browsing and eating, burrowing and or digging, or general consumption or disruption of a potted plants, planting beds, landscape, garden, or other foliage environment, by animals including but not limited to, squirrels, chipmunks, prairie dogs, gophers, woodchucks, and other members of the order rodentia family not referred to herein, as well as other types of animals such as raccoons, that would otherwise destroy or damage plant material and the surrounding region or soil.

### BACKGROUND OF THE INVENTION

### Field of the Invention

This invention relates generally to the field of animal repellents. Moreover it pertains specifically to an Animal Repellant & Method of Use Thereof that utilizes both granular and liquid embodiments for repelling animals such as squirrels, chipmunks, prairie dogs, gophers, woodchucks, raccoons, and other animals that would otherwise destroy or damage plant material and the surrounding region or soil.

### SUMMARY OF THE INVENTION

In view of the limitations now present in the prior art, the present invention provides a new and useful Animal Repellant & Method of Use Thereof, which is simpler in construction, more universally usable and more versatile in operation than known apparatus of this kind.

The purpose of the present invention is to provide a new Animal Repellant & Method of Use Thereof that utilizes both granular and liquid embodiments for repelling a variety of animals including squirrels, chipmunks, prairie dogs, gophers, woodchucks, raccoons, and other animals that would otherwise destroy or damage plant material and the surrounding region or soil. It is also a purpose of the present invention to provide a new Animal Repellant & Method of Use Thereof that has many novel features not offered by the prior art apparatus that result in a new Animal Repellant & Method of Use Thereof which is not apparent, obvious, or suggested, either directly or indirectly by any of the prior art apparatus.

The present invention disclosed herein, in the preferred embodiment, generally comprises a composition of materials or ingredients that combine to create a new and novel animal repellant, understanding that the composition may be embodied in a liquid form or in a granular form, whereby the liquid form is intended to be utilized in a manner which will allow the user to apply the composition to a variety of plant and other types of surfaces including but not limited in use to, buds, leaves, stems, exposed roots, bark, and other surfaces or object which an animal will chew or gnaw on, by means of a variety of application methods including but not limited in use to, blowing, ejecting, or spraying distribution methods whereby the liquid is blown, ejected, or sprayed in a jet of fine particles from an atomizer, sprayer, or other device which allows for direct application to all plant surfaces (buds, leaves, stems and bark), plant seeds, or other articles such as garbage or trash receptacles, bags or cans, to thereby repel animals, and thus prevent or reduce the incidence of chewing and gnawing by animals.

The present invention disclosed herein, may consist of an aqueous solution having the following ratios of ingredients, and may comprise a variety of total liquid volume: The following is a list of ingredients which are constant in the repellant disclosed herein as the invention.

Constant Ingredients:

1 to 3 parts of White Pepper Oil

7 to 10 parts of Garlic

5 to 9 parts of Castor Oil

3 to 6 parts of Citric Acid

0.1 to 0.2 parts of Sodium Laurel Sulfate

2 to 6 parts of Potassium Sorbate

0.20 to 0.50 parts of Xanthan Gum

And approximately 592 to 617 parts water

The following is a list of ingredients which may be added into the desired repellant mixture based on the intended use and application.

Variable Ingredients:

1 to 4 parts of Clove Oil and/or

1 to 4 parts of Cedar leaf Oil and/or

2 to 5 parts of Lemongrass Oil and

0.5 to 1.5 parts Sulfur

It is to be understood that the clay granules (fullers earth) portion of the invention will vary in relation to the liquid embodiment of the invention based on the amount of moisture already contained within the clay granules, which will have a direct impact on the saturation levels of the granules. The higher the moisture levels that are pre-existing in the clay granules, the lower the amount of liquid repellent required for the clay granules to reach a sufficient level of impregnated saturation.

The invention disclosed herein, in the granular embodiment, comprises a mixture of clay granules (fullers earth) which have been which have been impregnated with the above mixture. The clay granules are combined with the liquid embodiment of the invention, whereby the clay granules are allowed to absorb and become saturated with the liquid embodiment of the invention. Once the liquid is sufficiently absorbed by the clay granules, the dried ingredient White Pepper Powder is added in varying amounts whereby the amount to be added will result in varying degrees of potency while still performing the use and function disclosed herein.

It is to be understood that alternate embodiments of the invention may comprise the ingredients disclosed herein having varying percentages of one or a multitude of the ingredients disclosed herein as variable ingredients, whereby the variable ingredients may be used individually or in any combination thereof, in conjunction with the constant ingredients disclosed herein which provide the user with varying degrees of potency, while still performing the same function and therefore are to be considered apparent and obvious to the disclosure contained herein.

It is intended that the invention disclosed herein will be used as an animal repellant in liquid or granular form to discourage activities such as gnawing and eating, burrowing and or digging, or general consumption or disruption of a potted plants, planting beds, landscape, garden, or other foliage environment, by animals including but not limited to, squirrels, chipmunks, prairie dogs, gophers, woodchucks, and other members of the order rodentia family not referred to herein, as well as other types of animals such as raccoons, that would otherwise destroy or damage plant material and the surrounding region or soil. The liquid may be applied to all plant surfaces (buds, leaves, stems and bark), plant seeds, or other articles, to thereby repel animals, and thus prevent or reduce the incidence of chewing and gnawing by animals. The granular form may be sprinkled on mulched beds, or in flower pots to repel and discourage animals from digging and burrowing in the treated areas.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### Description of Related Art

Many methods and processes have been proposed for controlling or repelling animals such as rodents and vermin in residential and commercial, landscaping, and gardening environments.

One such method is found in U.S. Pat. No. 6,139,857 which discloses a process of providing an effective quantity of dry dusting sulfur and inserting said dusting sulfur into burrowing holes and other spaces traveled by rodents and vermin.

Another method is disclosed in U.S. Pat. No. 4,058,402 which describes a water soluble rodent repellent composition which can be coated onto a material, e.g., a cable, which is laid into the ground, and which comprises in a non-aqueous, liquid solvent, a solid, water-soluble, repellent holding dispersible carrier and an effective N,N-dialkylsulfenyl dithiocarbamate rodent repellent.

U.S. Pat. No. 6,923,977 issued to Boyce on Aug. 2, 2005 discloses a non-toxic animal repellant system which may be used to prevent squirrels from entering residential or commercial buildings using a composition having castor oil, habanero pepper extract and white distilled vinegar. The composition may be sprayed onto surfaces or combined with petroleum jelly and applied to surfaces with a brush.

However, the prior art methods and processes are limited in their application and functionality. U.S. Pat. No. 6,923,977, in one embodiment utilizes a petroleum based jelly to aid in the application of the repellant. This patent also describes a method of spraying the repellent onto a surface.

This spray application method, while somewhat effective for surface areas such as plants etc. is not effective for preventing animals from digging or damaging the ground or surrounding soil.

The method of dry dusting disclosed in U.S. Pat. No. 6,139,857, relies on simple dry dusting of the repellent, which requires an environment of use which is relatively lacking in wind as a windy environment would result in the dry dusting particles being simply blown off of any plant or ground surface and possibly into the eyes, nose, mouth, of any animal or human in close proximity to the dusted area.

It is therefore an object of the present invention to provide an improved more universal Animal Repellant & Method of Use Thereof that utilizes both granular and liquid embodiments for repelling animals in a wide variety of uses and applications.

### OBJECTIVES OF THE INVENTION

Accordingly several advantages and objects of the present invention are:

A principal objective of the present invention is to provide an Animal Repellant & Method of Use Thereof that will overcome the deficiencies of the prior art devices.

An objective of the present invention is to provide an Animal Repellant & Method of Use Thereof that will act to repel, ward off, or drive away animals from potted plants, planting beds, landscape, garden, or other foliage environments.

Another objective of the present invention is to provide an Animal Repellant & Method of Use Thereof that is offered in liquid and granular form.

Another objective of the present invention is to provide an Animal Repellant & Method of Use Thereof that will repel a variety of animals including squirrels, chipmunks, prairie dogs, gophers, woodchucks, and other members of the order rodentia family not referred to herein, as well as other types of animals such as raccoons.

Another objective of the present invention is to provide an Animal Repellant & Method of Use Thereof that repel a variety of animals from articles such as garbage or trash receptacles, bags or cans.

Another objective of the present invention is to provide an Animal Repellant & Method of Use Thereof that will minimize or prevent the incidence of animals burrowing, digging or disrupting areas where repellent was applied.

Another objective of the present invention is to provide an Animal Repellant & Method of Use Thereof that can be manipulated to create a variety of different potency levels.

Another objective of the present invention is to provide an Animal Repellant & Method of Use Thereof that will minimize or reduce the incidence of unwanted chewing or gnawing by a variety of animals.

Another objective of the present invention is to provide an Animal Repellant & Method of Use Thereof which is more versatile and compact than prior art devices.

It is intended that any other advantages and objectives of the present invention that become apparent or obvious from the detailed description or illustrations contained herein are within the scope of the present invention.

I claim:

1. An animal repellant comprising: (a) White Pepper Oil; (b) Garlic; (c) Castor Oil; (d) Citric Acid; (e) Sodium Laurel Sulfate; (f) Potassium Sorbate; (g) Xanthan Gum; (h) water; wherein the ratio of the volumes of the components in the whole composition is 1 to 3 parts of White Pepper Oil; 7 to 10 parts of Garlic; 5 to 9 parts of Castor Oil; 3 to 6 parts of Citric Acid; 0.1 to 0.2 parts of Sodium Laurel Sulfate; 2 to 6 parts of Potassium Sorbate; 0.20 to 0.50 parts of Xanthan Gum; and approximately 592 to 617 parts water.

2. The repellant as described in claim 1, wherein 1 to 4 parts of Clove Oil are added to the composition.

3. The repellant as described in claim 1, wherein 1 to 4 parts of Cedar Leaf Oil are added to the composition.

4. The repellant as described in claim 1, wherein 2 to 5 parts of Lemongrass Oil are added to the composition.

5. The repellant as described in claim 1, wherein 0.5 to 1.5 parts of Sulfur are added to the composition.

6. The repellant as described in claim wherein clay granules or fuller earth, are combined with the liquid embodiment of the invention, whereby the clay granules are allowed to absorb and become saturated with the composition.

7. The repellant as described in claim wherein once the liquid is sufficiently absorbed by clay granules, the dried ingredient White Pepper Powder is added.
